(19) United States
(12) Patent Application Publication
(10) Pub. No.: US 2010/0072962 A1
(43) Pub. Date: Mar. 25, 2010

(54) DC/DC SWITCHED-MODE CONVERTER WITH A PERIOD BIFURCATION CONTROL MECHANISM

(76) Inventors: Heng-Li Lin, Taipei City (TW); Cheng-Kuang Lin, Nantou City (TW); Tzung-Ling Tsai, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/350,206

(22) Filed: Jan. 7, 2009

(30) Foreign Application Priority Data
Sep. 25, 2008 (TW) 097136825

(51) Int. Cl. G05F 1/56

(52) U.S. Cl. 323/282

(57) ABSTRACT

A DC-DC switched mode converter includes a voltage conversion circuit, a switch control circuit, a duty cycle detector, a control signal generator, and a control signal selector. The switch control circuit generates a first control signal. The duty cycle detector detects a duty cycle of the first control signal so as to generate a detection signal. The control signal generator generates a second control signal. The control signal selector outputs the first control signal or the second control signal for controlling the voltage conversion circuit according to the detection signal.

### BACKGROUND OF THE INVENTION

1. Field of the Invention

The present invention relates to a DC/DC switched-mode converter, and more particularly, to a DC/DC switched-mode converter with a period bifurcation control mechanism.

2. Description of the Prior Art

In general, there are only few major voltage source levels provided in the electronic products, for example, 1 2 and 9 volts. However, there are various integrated circuits with different functions in the system and these integrated circuits are operated at different voltage levels, for example, 5 and 3.3 volts. In such a condition, a converter is necessary for converting voltage levels.

Please refer to FIG. 1. FIG. 1 is a diagram illustrating a DC/DC step-down buck converter 100. The DC/DC step-down buck converter 100 includes an input voltage source Vin, a transistor 101, a diode 102, an inductor 103 and a capacitor 104. The input voltage source Vin is coupled to the drain of the transistor 101. The source of the transistor 101 is coupled to the first end of the diode 102. The second end of the diode 102 is coupled to a ground end. The first end of the inductor 103 is coupled to the source of the transistor. The second end of the inductor is coupled to the first end of the capacitor 104. The second end of the capacitor 104 is coupled to the ground end. When the transistor 101 is turned on, the input voltage source Vin supplies power to the inductor 103 and the load of the output end. Meanwhile, the diode 102 is reversely cut-off and the voltage drop across the inductor 103 causes the current passing through the inductor 103 to rise linearly for storing energy. The current passing through the inductor 103, in addition to providing the required current for the load, also charges the capacitor 104. When the transistor 101 is turned off, the input voltage source Vin can not supply power to the inductor 103. In such way, the voltage polarity of the inductor 103 reverses so that the diode is forward conducted by the released energy from the inductor 103. The energy stored in the inductor 103 and the capacitor 104 is transferred to the load by the loop formed by the inductor 103, the capacitor 104 and the diode 102. The current passing through the inductor 103 keeps decreasing until the transistor 101 is turned on again.

Please refer to FIG. 2. FIG. 2 is a diagram illustrating waveforms of the control signal VG1 that controls the transistor 101 and the output voltage Vo of the DC/DC step-down buck converter 100. When the control signal VG1 is corresponding to a high voltage level, the output voltage Vo gradually rises. When the control signal VG1 is corresponding to a low voltage level, the output voltage Vo gradually decreases. The relationship between the average of the output voltage Vo and the input voltage Vin is:

$$\frac{Vo}{Vin} = D$$

wherein D is equal to Ton/T, which means the duty cycle of the control signal VG1. Thus, adjusting the duty ratio of the control signal VG1 generates the different output voltage Vo.

Please refer to FIG. 3. FIG. 3 is a diagram illustrating waveforms of the output voltage Vo of the DC/DC step-down buck converter 100 with period bifurcation. If the transistor 101 is switched on at the beginning of every cycle, when the duty cycle is less than 50%, the waveform output voltage Vo has only one steady state and the phenomenon of the period bifurcation does not appear. When the duty cycle is more than 50%, if the output voltage Vo does not reach to the predetermined voltage level in a duty cycle, the transistor 101 will keep conducted in the next duty cycle. In this way, a second steady state is possibly generated on the waveform of the output voltage Vo, wherein the frequency of the second steady state is half of the frequency of the first steady state, which is called period doubling bifurcation. When the duty cycle is more than 67%, a third steady state is possibly generated on the waveform of the output voltage Vo. Once the output voltage Vo enters the second state, the output voltage Vo hardly returns to the first steady state. In such way, the frequency of the output voltage Vo is not as required and additionally the ripple of the output voltage becomes more apparent as well.

### SUMMARY OF THE INVENTION

The present invention provides a DC/DC step-down buck converter with a period bifurcation control mechanism. The DC/DC step-down buck converter comprises a first switch, a second switch, an inductor, a capacitor, a switch control circuit, a duty cycle detector, a control signal generator and a control signal selector. The first switch is coupled between a first voltage source end and a first node. The second switch is coupled between the first node and a second voltage source end. The inductor, coupled between the first node and a second node. The capacitor is coupled between the second node and the second voltage source end. The switch control circuit is coupled to the second node for generating a first control signal. The duty cycle detector is coupled to the switch control circuit for detecting the duty cycle of the first control signal so as to generate a detection signal. The control signal generator is utilized for generating a second control signal. The control signal selector is coupled to the switch control circuit, the duty cycle detector and the control signal generator for outputting the first control signal or the second control signal according to the detection signal so as to control the first switch.

The present invention further provides a DC/DC switched-mode converter with a period bifurcation control mechanism. The DC/DC switched-mode converter comprises a voltage converter circuit, a switch control circuit, a switch control circuit, a duty cycle detector, a control signal generator and a control signal selector. The voltage converter circuit is utilized for transforming a voltage level. The switch control circuit is coupled to the voltage converter circuit for generating a first control signal. The duty cycle detector is coupled to the switch control circuit for detecting the duty cycle of the first control signal so as to generate a detection signal. The control signal generator is utilized for generating a second control signal. The control signal selector is coupled to the switch control circuit, the duty cycle detector and the control signal generator for outputting the first control signal or the second control signal according to the detection signal so as to control the voltage converter circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a DC/DC step-down buck converter.

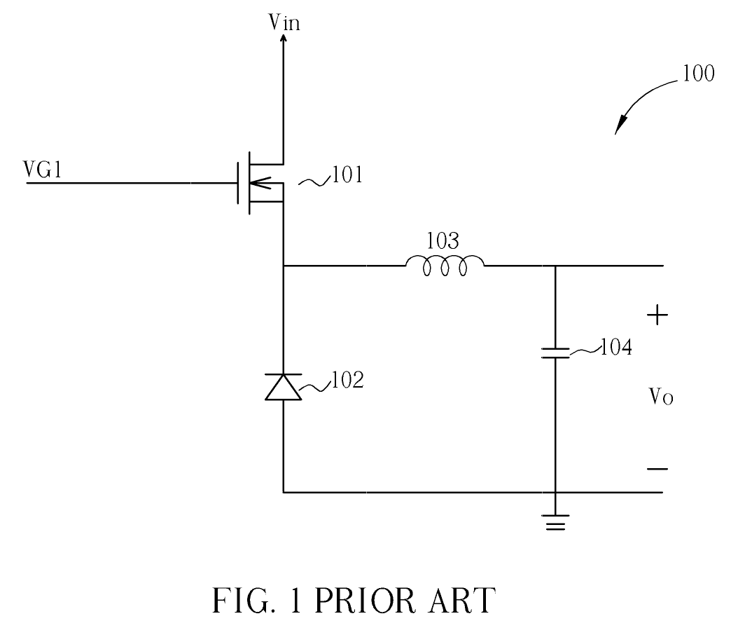

FIG. 2 is a diagram illustrating waveforms of the control signal that controls the transistor and the output voltage of the DC/DC step-down buck converter.

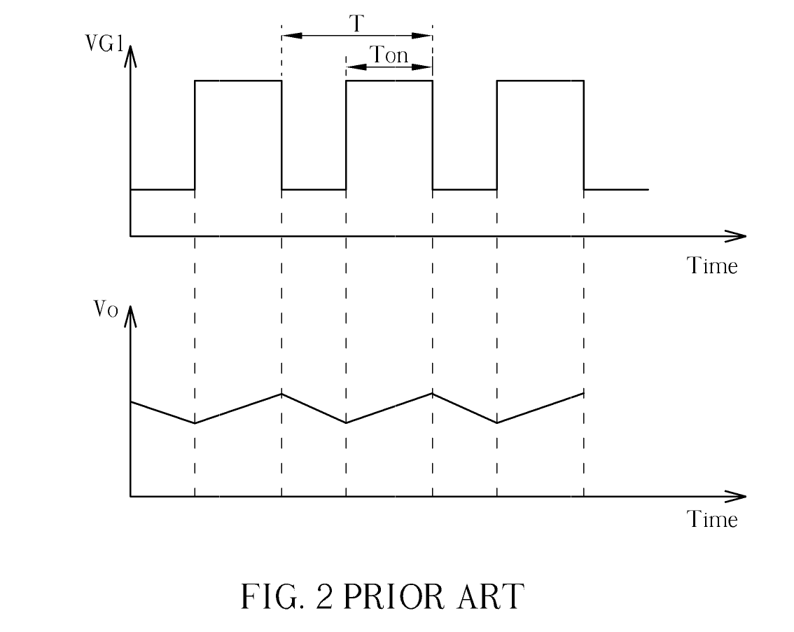

FIG. 3 is a diagram illustrating waveforms of the output voltage of the DC/DC step-down buck converter with period bifurcation.

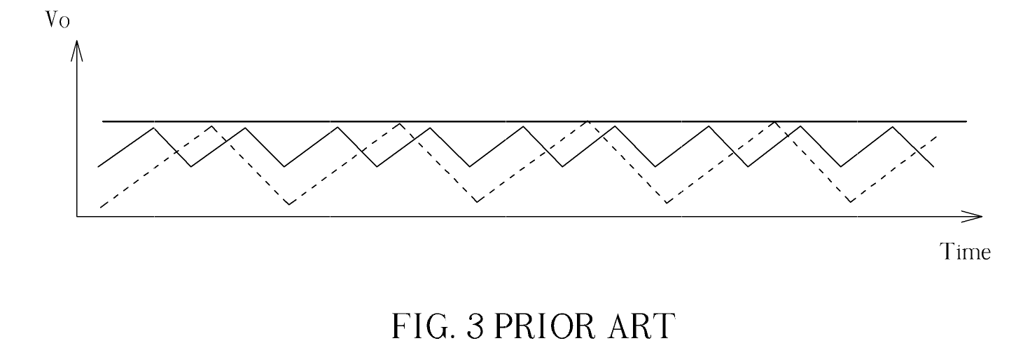

FIG. 4 is a block diagram of an embodiment illustrating a DC/DC step-down buck converter according to the present invention.

FIG. 5 is a circuitry illustrating the switch control circuit in FIG. 4.

FIG. 6 is a circuitry illustrating the duty cycle detector in FIG. 4.

FIG. 7 is a diagram illustrating waveforms of the signal of the DC/DC step-down buck converter.

### DETAILED DESCRIPTION

The energy-storage element is utilized in the DC/DC switched-mode converter for storing the input energy and then releasing the stored energy so as to change the voltage level into another voltage level, wherein the energy-storage element comprises the inductor or the capacitor. The function of the DC/DC switched-mode converter is that when the input voltage and the output load are unstable, the output voltage is still adjusted to keep at the predetermined voltage level. In general, the average magnitude of the output voltage is changed by means of controlling the duty cycle that the switch is conducted. The DC/DC switched-mode converter comprises the step-down buck converter, the step-up boost converter, and the step-down/step-up buck-boost converter. The step-down buck converter and the step-up boost converter are the fundamental structures of the converter circuit and the step-down/step-up buck-boost converter is the combination of the two fundamental converters. In the embodiment of the present invention, the step-down buck converter is illustrated. However, the present invention is applied for the step-up boost converter and the step-down/step-up buck-boost converter as well.

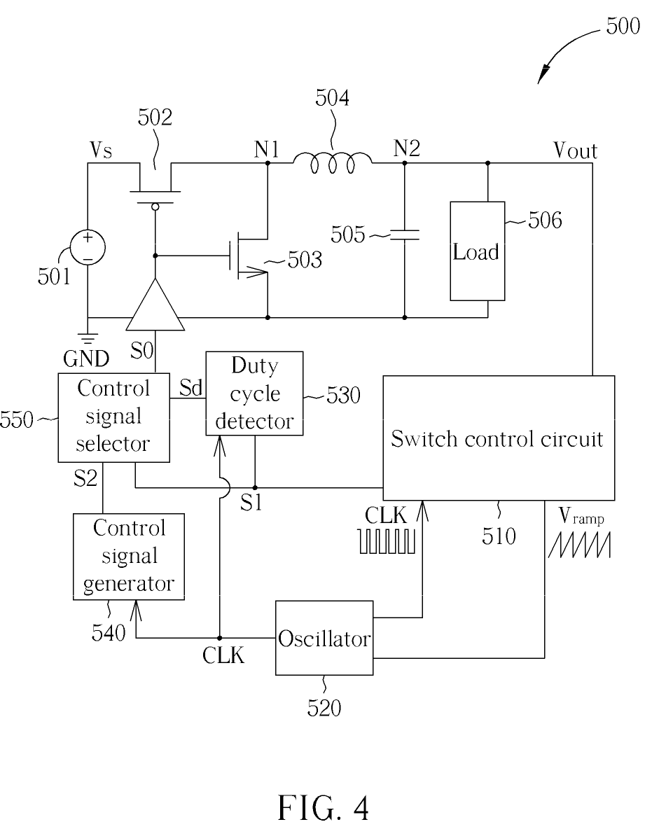

Please refer to FIG. 4. FIG. 4 is a block diagram of an embodiment illustrating a DC/DC step-down buck converter 500 according to the present invention. The DC/DC step-down buck converter 500 comprises a supply voltage source 501, a first switch 502, a second switch 503, an inductor 504, a capacitor 505, a load 506, a switch control circuit 510, an oscillator 520, a duty cycle detector 530, a control signal generator 540 and a control signal selector 550. The first switch 502 is coupled between a voltage source end Vs and a first node N1. The second switch is coupled between the first node N1 and a ground end GND. The inductor 502 is coupled between the first node N1 and a second node N2. The capacitor 505 is coupled between the second node N2 and the ground end GND. The switch control circuit 510 is coupled to the node N2 and utilized for generating a first control signal S1. The duty cycle detector 530 is coupled to the switch control circuit 510 and utilized for detecting the duty cycle of the first control signal S1 so as to generate a detection signal Sd. The control signal generator is utilized for generating a second control signal S2. The control signal selector 550 is coupled to the switch control circuit 510, the duty cycle detector 530 and the control signal generator 540 for outputting the first control signal S1 or the second control signal S2 according to the detection signal Sd so as to control the first switch 502. The oscillator 520 is utilized for providing the clock signal CLK to the switch control circuit 510, the duty cycle detector 530 and the control signal generator 540. In the embodiment, the first switch 502 is a P channel Metal Oxide Semiconductor (PMOS) transistor and the second switch is an N channel Metal Oxide Semiconductor (NMOS) transistor. However, the second switch also can be realized with a diode. When the first switch 502 is turned on, the second switch 503 is turned off. When the first switch 502 is turned off, the second switch 503 is turned on.

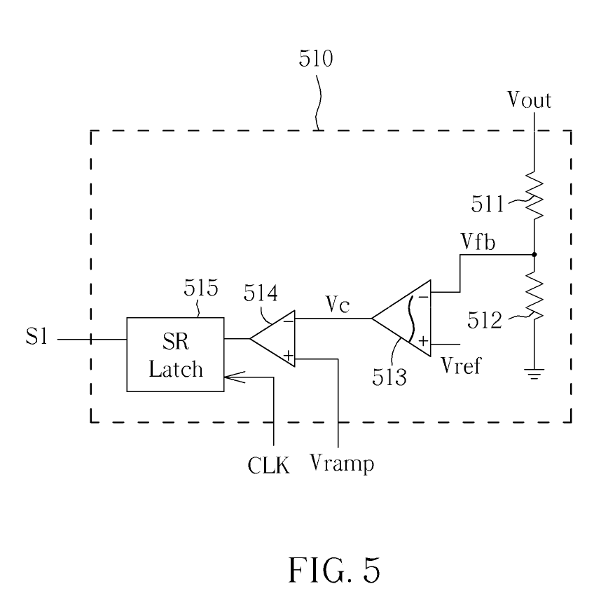

Please refer to FIG. 5. FIG. 5 is a circuitry illustrating the switch control circuit 510 in FIG. 4. The switch control circuit 510 comprises a first resistor 511, a second transistor 512, an error integrator 513, a comparator 514 and a SR latch 515. When the first switch 502 is turned on and the second switch is turned off, the voltage source Vs charges the inductor 504 and outputs the voltage to the node N2. When the first switch 502 is turned off and the second switch 503 is turned on, the voltage polarity of the inductor 504 reverses and the inductor 504 releases the stored energy to the capacitor 505 and the load 506. The switch control circuit 510 determines the duty cycle of the first control signal S1 according to the output voltage Vout on the node N2. The output voltage Vout generates the feedback voltage Vfb by means of the first resistor 511 and the second resistor 512. The error integrator 513 integrates the error between the feedback voltage Vfb and a reference voltage Vref and then the output voltage Vc of the error integrator 513 is compared with a ramp voltage Vramp. When the voltage Vc is lower than the ramp voltage Vramp, the SR latch 515 is triggered to turn off the first switch 502.

The switch control circuit 510 generates a first control signal S1 according to the output voltage Vout of the DC/DC step-down buck converter 500. When the duty cycle of the first control signal S1 is more than 50%, the output voltage Vout of the DC/DC step-down buck converter 500 will possibly generate period bifurcation. That is, there is possibly more than one steady state in the waveform of the output voltage Vout. As a result, the DC/DC step-down buck converter 500 of the present invention utilizes the duty cycle detector 530, the control signal generator 540 and the control signal selector 550 to change the control signal for keeping just one steady state in the output voltage Vout of the DC/DC step-down buck converter. The duty cycle detector 530 detects the first control signal S1 so as to generate a detection signal Sd. When the duty cycle of the first control signal S1 is more than 100%, the detection signal Sd outputted from the duty cycle detector 530 is at the high voltage level. The control signal generator 540 outputs a second control signal S2 with a predetermined duty cycle. The control signal selector 550 determines to output the first control signal S1 or the second control signal S2 according to the detection signal Sd. When the detection signal Sd is at the low voltage level, the control signal selector 550 outputs the first control signal S1. When the detection signal Sd is at the high voltage level, the control signal selector 550 outputs the first control signal S1 or the second control signal S2. Supposed that the duty cycle of the second control signal S2 is 50%, when the duty cycle detector 530 detects that the duty cycle of the first control signal S1 is higher than 100%, the minimum average duty cycle of the control signal SO outputted from the control signal selector 550 for two consecutive cycles can be represented as:

$$\frac{100 \% + 50 \%}{100 \% + 100 \%} = 75 \%$$

The resulting duty cycle thus eliminates any possible bifurcation steady states originally existing for the duty cycle below 75%.

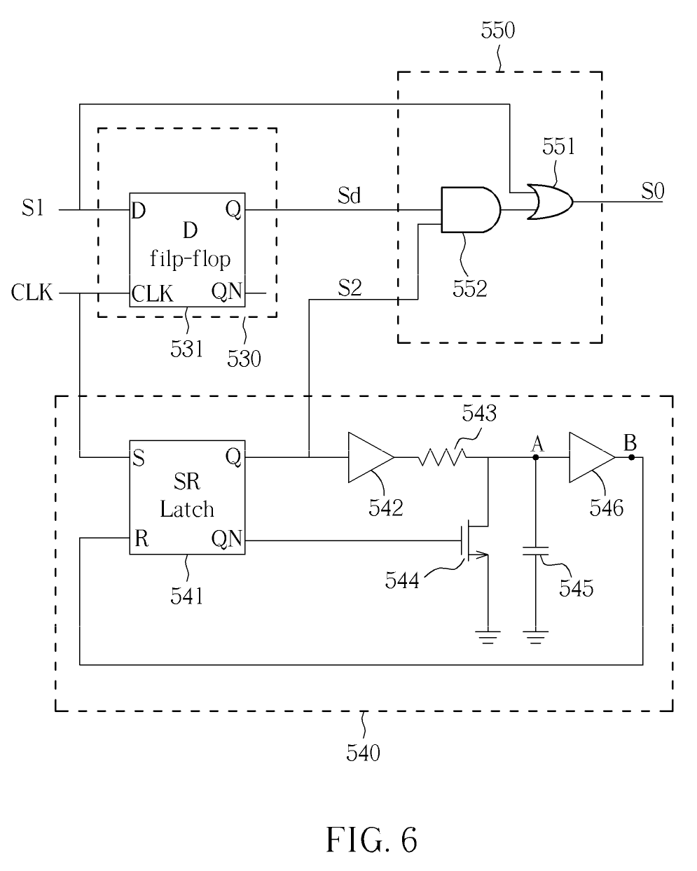

Please refer to FIG. 6. FIG. 6 is a circuitry illustrating the duty cycle detector 530, the control signal generator 540, and the control signal selector 550 in FIG. 4. The duty cycle detector 530 comprises a D flip-flop 531. The input end D of the D flip-flop 531 receives the first control signal S1. The input end CLK of the D-flip flop receives the clock signal generated from the oscillator 520. The output end Q of the D flip-flop 531 outputs the detection signal Sd. The control signal generator 540 comprises a SR latch 541, a first buffer 542, a resistor 543, a transistor 544, a capacitor 545, and a second buffer 546. The input end S of the SR latch 541 receives the clock signal generated from the oscillator 520. The first buffer 542, the resistor 543, and the second buffer 546 are coupled in serial between the input end Q of the SR latch 541 and the input end R of the SR latch 541. The transistor 544 and the capacitor 545 are coupled in parallel between the input end A of the second buffer 546 and the ground end. The input end QN of the SR latch 541 is coupled to the gate of the transistor 544. The duty cycle of the control signal generated by the control signal generator is determined the RC time constant formed by the transistor 543 and the capacitor 545. The control signal selector 550 comprises an AND gate 552 and an OR gate 551. The first control signal S2 is inputted to the first input end of the AND gate 552, and the detection signal Sd is inputted to the second input end of the AND gate 552. The first input end of the OR gate 551 is coupled to the input end D of the D flip-flop 531 and the second input end of the OR gate 551 is coupled to the output end of the AND gate 552. When the detection signal Sd is at the low voltage level, the control signal selector 550 outputs the first control signal S1. When the detection signal Sd is at the high voltage level, the control signal selector 550 outputs the control signal S1 or the control signal S2.

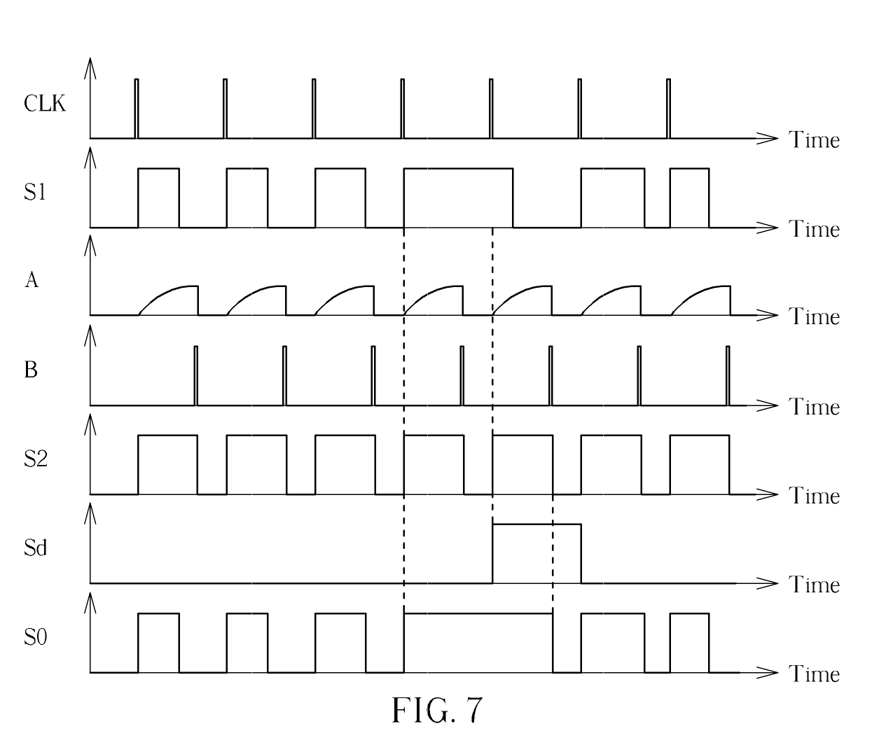

Please refer to FIG. 7. FIG. 7 is a diagram illustrating waveforms of the signals of the DC/DC step-down buck converter 500. The signal CLK is the clock signal generated by the oscillator 520. The signal S1 is the first control signal generated by the switch control circuit 510. The signal A is the signal of the input end A of the second buffer 546. The signal B is the signal of the output end B of the second buffer 546. The signal S2 is the second control signal generated by the control signal generator 540. The signal Sd is the detection signal generated by the duty cycle detector 530. The signal S0 is the control signal generated from the control signal selector 550. When the signal S1 keeps at the high voltage level for one cycle, it means the duty cycle of the signal S1 is more than 100%. In the condition, the detection signal Sd outputted from the duty cycle detector 530 is pulled up to the high voltage level so that the control signal selector 550 can output the control signal S1 or the control signal S2. Consequently, when the signal Sd is at the low voltage level, the signal S0 has the same voltage level as the signal S1. When the signal Sd is at the high voltage level, the signal S0 has the same voltage level as the control signal S1 or the control signal S2.

In conclusion, the present invention discloses a DC/DC switched-mode converter with a period bifurcation control mechanism. The embodiment of the present invention is illustrated by a DC/DC step-down buck converter. When the duty cycle of the control signal of the DC/DC step-down buck converter is more than 100% in one clock cycle, the outputted control signal in the next clock cycle signal is forced to have a predetermined minimum duty. Hence, the period bifurcation phenomenon in the DC/DC step-down buck converter is mitigated. The DC/DC switched-mode converter comprises a voltage transformer circuit, a switch control circuit, a duty cycle detector, a control signal generator and a control signal selector. The switch control circuit generates a first control signal. The duty cycle detector detects the duty cycle of the first control signal so as to generate a detection signal. The control signal generator generates a second control signal. The control signal selector outputs the first control signal or the second control signal according to the detection signal so as to control the voltage transformer circuit. The present invention can be applied for the DC/DC converters, comprising the step-down buck converter, the step-up boost converter and the step-down/step-up buck-boost converter.

Those skilled in the art will readily observe that numerous modifications and alterations of the device and method may be made while retaining the teachings of the invention.

What is claimed is:

1. A DC/DC step-down buck converter with a period bifurcation control mechanism, comprising:
a first switch, coupled between a first voltage source end and a first node;
a second switch, coupled between the first node and a second voltage source end;
an inductor, coupled between the first node and a second node;
a capacitor, coupled between the second node and the second voltage source end;
a switch control circuit, coupled to the second node, for generating a first control signal;
a duty cycle detector, coupled to the switch control circuit, for detecting the duty cycle of the first control signal so as to generate a detection signal;
a control signal generator, for generating a second control signal; and
a control signal selector, coupled to the switch control circuit, the duty cycle detector and the control signal generator, for outputting the first control signal or the second control signal according to the detection signal so as to control the first switch.

2. The DC/DC step-down buck converter of the claim 1, wherein the duty cycle detector is utilized for detecting if the duty cycle of the first control signal is more than 100%.

3. The DC/DC step-down buck converter of the claim 1, wherein the duty cycle detector comprises:
a D flip-flop, having an input end for receiving the first control signal, and an output end for generating the detection signal.

4. The DC/DC step-down buck converter of the claim 1, wherein the control signal generator comprises:
a SR latch;
a first buffer, coupled to a positive output end of the SR latch;
a resistor, coupled to an output end of the first buffer;
a transistor, coupled between the resistor and a ground end, a gate of the transistor coupled to a negative output end of the SR latch;
a capacitor, coupled in parallel to the transistor; and
a second buffer, coupled between the resistor and a reset input end of the SR latch.

5. The DC/DC step-down buck converter of the claim 1, wherein the control signal selector comprises:
a first transmission gate, for transmitting the first control signal; and
a second transmission gate, for transmitting the second control signal.

6. The DC/DC step-down buck converter of the claim 1, wherein the switch control circuit comprises:
a first resistor, coupled to the second node;
a second resistor, coupled to the first resistor for generating a feedback voltage;
an error integrator, for integrating the error between the feedback voltage and a reference voltage;
a comparator, for comparing an output signal of the error integrator and a ramp voltage; and
a SR latch, for generating the first control signal according an output signal of the comparator.

7. The DC/DC step-down buck converter of the claim 1, wherein when the first switch is turned on, the second switch is turned off, and when the first switch is turned off, the second switch is turned on.

8. The DC/DC step-down buck converter of the claim 1, wherein the first switch is a transistor and the second switch is a diode.

9. A DC/DC switched-mode converter with a period bifurcation control mechanism, comprising:
a voltage transformer circuit, for changing a voltage level;
a switch control circuit, coupled to the voltage transformer circuit, for generating a first control signal;
a duty cycle detector, coupled to the switch control circuit for detecting the duty cycle of the first control signal so as to generate a detection signal;
a control signal generator, for generating a second control signal; and
a control signal selector, coupled to the switch control circuit, the duty cycle detector and the control signal generator, for outputting the first control signal or the second control signal according to the detection signal so as to control the voltage transformer circuit.

10. The DC/DC switched-mode converter of the claim 9, wherein the duty cycle detector comprises:
a D flip-flop, having an input end for receiving the first control signal, and an output end for generating the detection signal.

11. The DC/DC switched-mode converter of the claim 9, wherein the control signal generator comprises:
a SR latch;
a first buffer, coupled to a positive output end of the SR latch;
a resistor, coupled to the output end of the first buffer;
a transistor, coupled between the resistor and a ground end, a gate of the transistor is coupled to a negative output end of the SR latch;
a capacitor, coupled in parallel to the transistor; and
a second buffer, coupled between the resistor and a reset input end of the SR latch.

12. The DC/DC switched-mode converter of the claim 9, wherein the control signal selector comprises:
an AND gate, having a first input end for receiving the detection signal, and a second input end for receiving the second control signal; and
an OR gate, having a first input end coupled to an output end of the AND gate, and a second input end for receiving the first control signal.

13. The DC/DC switched-mode converter of the claim 9, wherein the DC/DC switched-mode converter is a step-down buck converter.

14. The DC/DC switched-mode converter of the claim 9, wherein the DC/DC switched-mode converter is a step-up boost converter.

15. The DC/DC switched-mode converter of the claim 9, wherein the DC/DC switched-mode converter is a step-down/step-up buck-boost converter.
